(19) United States
(12) Patent Application Publication
(10) Pub. No.: US 2025/0202570 A1
(43) Pub. Date: Jun. 19, 2025

(54) NETWORK CONTROLLED UE ANALOG RECEPTION PRECODING

(71) Applicant: QUALCOMM Incorporated, San Diego, CA (US)

(72) Inventors: Jacob PICK, Mevaseret Zion (IL); Assaf TOUBOUL, Netanya (IL); Shay LANDIS, Hod Hasharon (IL); Gideon Shlomo KUTZ, Ramat Hasharon (IL); Guy WOLF, Rosh Haayin (IL); Peer BERGER, Hod Hasharon (IL); Tomer GEVA, Kiryat Ono (IL)

(21) Appl. No.: 18/389,685

(22) Filed: Dec. 19, 2023

(51) Int. Cl. H04B 7/08; H04L 5/00

(52) U.S. Cl. CPC H04B 7/086; H04L 5/005

(57) ABSTRACT

The apparatus may be a UE configured to obtain a configuration for an antenna identification associated with a plurality of antennas at the UE, output, for a network device and based on the configuration for the antenna identification, a set of antenna identification signals, and obtain, based on the set of antenna identification signals, analog reception combining information. The apparatus may also be configured to communicate with the network device based on the analog reception combining information. The apparatus may be a network device configured to output a configuration for an antenna identification associated with a plurality of antennas at a UE, obtain, from the UE and based on the configuration for the antenna identification, a set of antenna identification signals, and output, based on the set of antenna identification signals, analog reception combining information.

### TECHNICAL FIELD

The present disclosure relates generally to communication systems, and more particularly, to a method of wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) configured to obtain a configuration for an antenna identification associated with a plurality of antennas at the UE. The apparatus may further be configured to output, for a network device and based on the configuration for the antenna identification, a set of antenna identification signals and obtain, based on the set of antenna identification signals, analog reception combining information. The apparatus may also be configured to communicate with the network device based on the analog reception combining information.

In an aspect of the disclosure, a method, a computer-readable medium, and an apparatus are provided. The apparatus may be a network device configured to output a configuration for an antenna identification associated with a plurality of antennas at a UE. The apparatus may further be configured to obtain, from the UE and based on the configuration for the antenna identification, a set of antenna identification signals and output, based on the set of antenna identification signals, analog reception combining information. The apparatus may also be configured to communicate with the UE based on the analog reception combining information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating multiple antennas, a corresponding set of analog Rx chains, and a set of digital Rx chains that may be associated with a wireless device (or UE) in accordance with some aspects of the disclosure.

FIG. 5 is a set of diagrams illustrating aspects of determining the channel between each Tx antenna of a network device and each RX antenna of a UE in accordance with some aspects of the disclosure.

FIG. 6 is a diagram illustrating a set of inputs and outputs associated with Rx analog precoding and/or antenna selection in accordance with some aspects of the disclosure.

FIG. 7 is a call flow diagram illustrating a method of wireless communication associated with analog reception combining in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

In some aspects of wireless communications, higher frequency ranges may be used and the number of antennas in use at wireless devices (e.g., UEs) may increase significantly. For example, at 20 GHz, 64 antennas may be used at a UE. Processing full digital chains of such a large number of antennas at the UE, may be associated with significant power consumption. A network device (e.g., a base station), in some aspects, may have knowledge of the full channel from all the Tx antennas, to all the analog reception (Rx) antennas of the UE.

Various aspects relate generally to analog reception combining. Some aspects more specifically relate to a multi-antenna transmitting device (e.g., a network device) and/or a multi-antenna receiving device (e.g., a UE) associated with a joint Tx precoding and/or Rx antenna precoding and/or selection based on the knowledge of the full channel between the transmitting device and the receiving device. In some examples, the UE may be configured to obtain a configuration for an antenna identification associated with a plurality of antennas at the UE. The UE may further be configured to output, for a network device and based on the configuration for the antenna identification, a set of antenna identification signals and obtain, based on the set of antenna identification signals, analog reception combining information. The UE may also be configured to communicate with the network device based on the analog reception combining information. In some examples, the network device may be configured to output a configuration for an antenna identification associated with a plurality of antennas at a UE. The network device may further be configured to obtain, from the UE and based on the configuration for the antenna identification, a set of antenna identification signals and output, based on the set of antenna identification signals, analog reception combining information. The network device may also be configured to communicate with the UE based on the analog reception combining information.

Particular aspects of the subject matter described in this disclosure can be implemented to realize one or more of the following potential advantages. In some examples, by reducing the number of analog Rx chains in association with an optimized precoding and/or selection, the described techniques can be used to reduce a power consumption while minimizing capacity loss.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

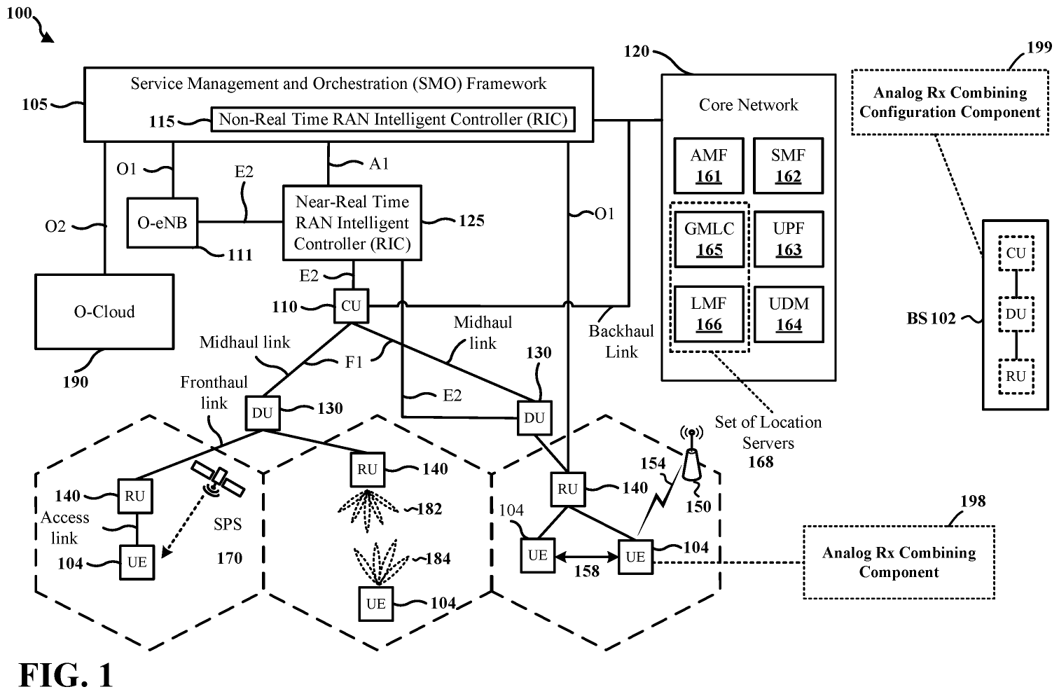

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an analog reception (Rx) combining component 198 that may be configured to obtain a configuration for an antenna identification associated with a plurality of antennas at the UE. The analog Rx combining component 198 may further be configured to output, for a network device and based on the configuration for the antenna identification, a set of antenna identification signals and obtain, based on the set of antenna identification signals, analog reception combining information. The analog Rx combining component 198 may also be configured to communicate with the network device based on the analog reception combining information. In certain aspects, the base station 102 may have an analog Rx combining configuration component 199 that may be configured to output a configuration for an antenna identification associated with a plurality of antennas at a UE. The analog Rx combining configuration component 199 may further be configured to obtain, from the UE and based on the configuration for the antenna identification, a set of antenna identification signals and output, based on the set of antenna identification signals, analog reception combining information. The analog Rx combining configuration component 199 may also be configured to communicate with the UE based on the analog reception combining information. Although the following description may be focused on 5G NR, the concepts described herein may be applicable to other similar areas, such as LTE, LTE-A, CDMA, GSM, and other wireless technologies.

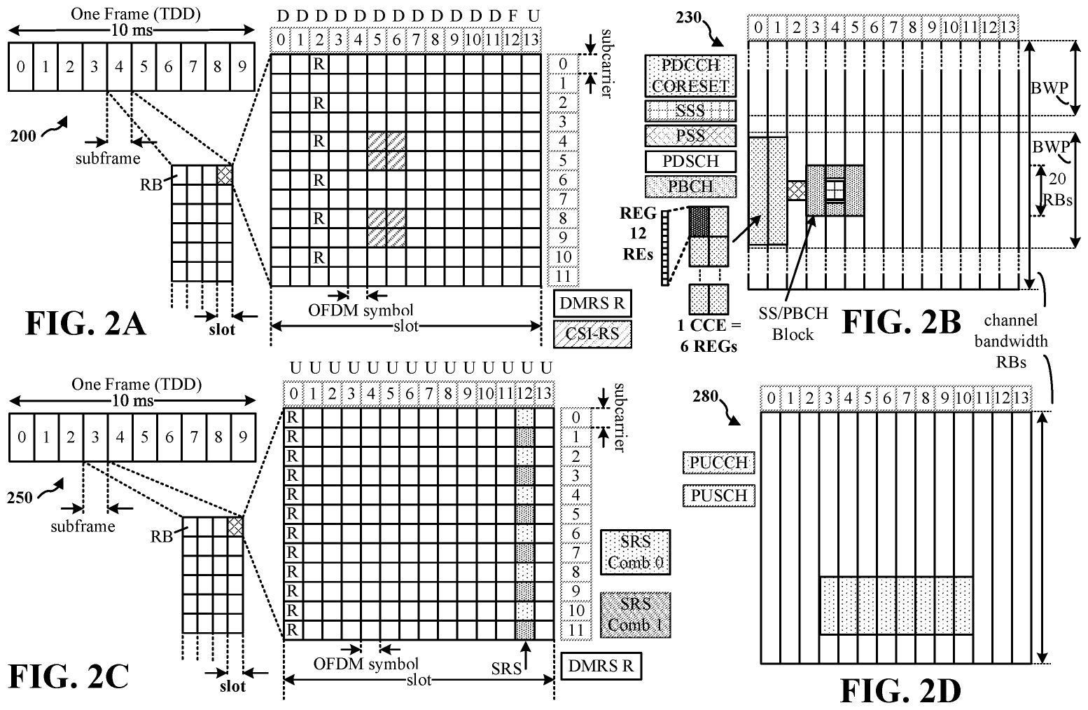

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

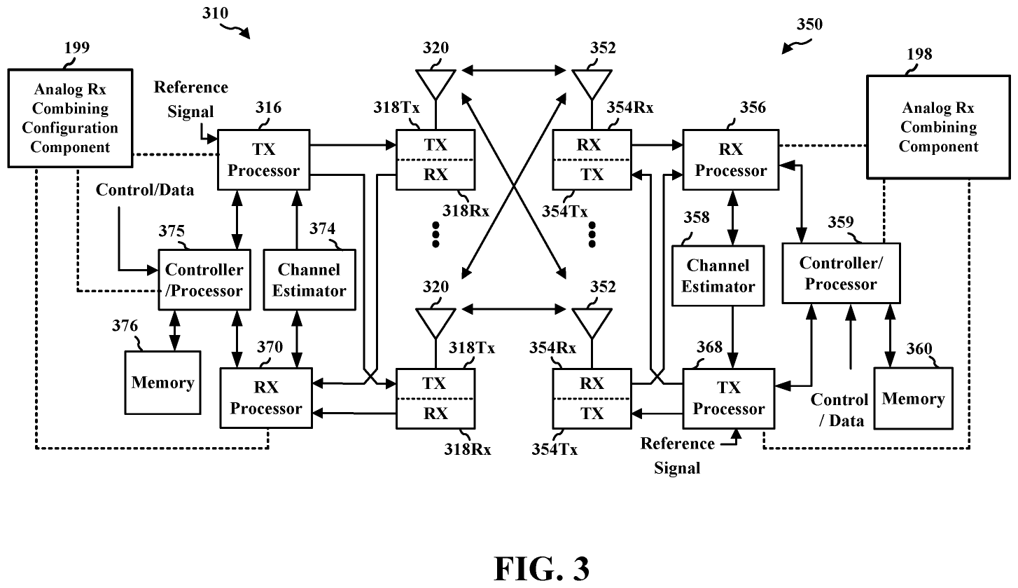

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the analog Rx combining component 198 of FIG. 1.

At least one of the TX processor 316, the RX processor 370, and the controller/processor 375 may be configured to perform aspects in connection with the analog Rx combining configuration component 199 of FIG. 1.

In some aspects of wireless communications, higher frequency ranges may be used and the number of antennas in use at wireless devices (e.g., UEs) may increase significantly. For example, at 20 GHz, 64 antennas may be used at a UE. Processing full digital chains of such a large number of antennas at the UE, may be associated with significant power consumption.

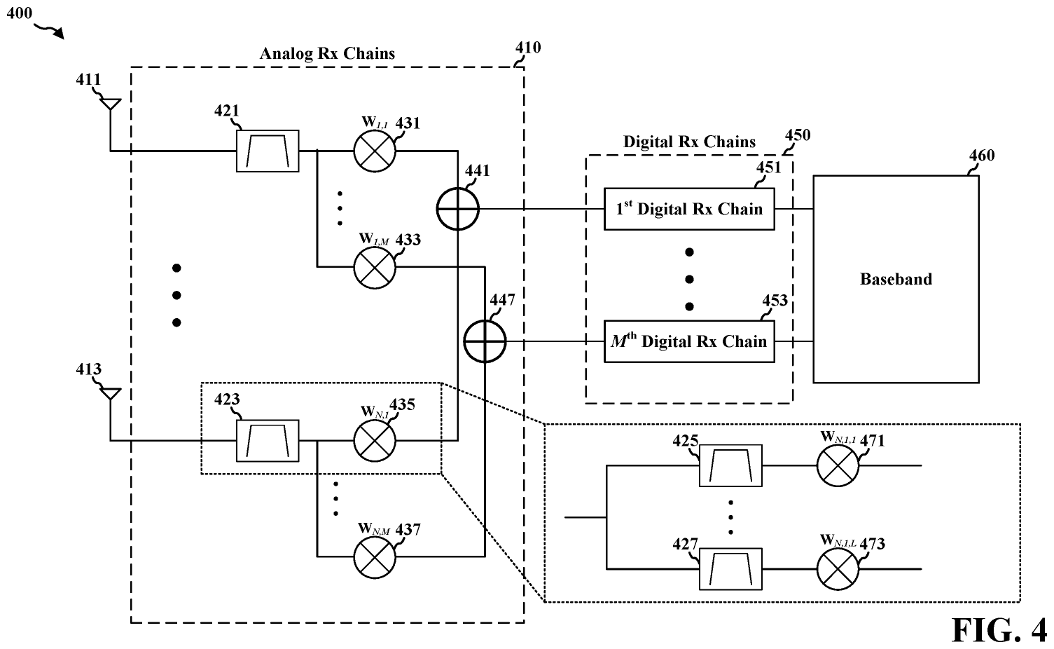

FIG. 4 is a diagram 400 illustrating multiple antennas, a corresponding set of analog Rx chains 410 (e.g., a set of N analog Rx chains), and a set of digital Rx chains 450 (e.g., a set of M digital Rx chains) that may be associated with a wireless device (or UE) in accordance with some aspects of the disclosure. For example, diagram 400 illustrates a set of antennas including antenna 411 to antenna 413. Each antenna, in some aspects, may be associated with a corresponding analog Rx chain including a set of analog processing components such as a phase shifter, a band pass filter, and a weighting component (that may incorporate a phase shifter). For example, the antenna 411, in some aspects, may be associated with a first analog Rx chain including a set of analog processing components such as a phase shifter, one or more band pass filters 421, and a set of weighting components (e.g., including weighting component 431 to weighting component 433) associated with a corresponding set of weights W_{1,1} to W_{1,M} that may be used to adjust one or more of a phase or a gain for a corresponding digital Rx chain of the set of digital Rx chains 450. Similarly, the antenna 413, in some aspects, may be associated with an additional analog Rx chain including a set of analog processing components such as a phase shifter, one or more band pass filters 423, and a set of weighting components (e.g., including weighting component 435 to weighting component 437) associated with a corresponding set of weights W_{N,1} to W_{N,M} that may be used to adjust one or more of a phase or a gain for a corresponding digital Rx chain of the set of digital Rx chains 450. Diagram 400 further illustrates that the one or more band pass filters 423 may include a first band pass filter 425 associated with a first frequency band and an L^{th} band pass filter associated with an L^{th} frequency band. Each band pass filter may be associated with a corresponding weighting component for a corresponding frequency band (e.g., weighting component 471 associated with the first frequency band and weighting component 473 associated with the L^{th} frequency band corresponding to weights W_{N,1,1} and W_{N,1,L}).

The received signals associated with the analog Rx chains may be combined based on the weights associated with the weighting components at a combining component (e.g., one or more of combining component 441 or combining component 447) before being provided to a digital Rx chain. For example, the received signals associated with the analog Rx chains may be combined based on the weights associated with the weighting components 431 and 435 (or the weighting components 433 and 437) at a combining component 441 (or combining component 447) before being provided to a first digital Rx chain 451 (or an M^{th} digital Rx chain 453) in the set of digital Rx chains 450. As illustrated in diagram 400, the number of analog Rx chains in the set of analog Rx chains 410 may be larger than the number of digital Rx chains in the set of digital Rx chains 450. The digital Rx chains 451 and 453, in some aspects, may provide a processed signal to a baseband processor 460 for decoding. The use of large numbers of antennas, analog Rx chains, and digital Rx chains may lead to significant power consumption.

As illustrated in diagram 400, each antenna may be associated with a single set of components (e.g., band pass filter 421, and weighting component 431) or each antenna may be associated with multiple processing paths each including a different set of components or a same set of components for different frequency bands of the received signal. For example, an antenna may be associated with a first set of components (e.g., band pass filter 425, and weighting component 471) for a first band and one or more additional sets of components (e.g., a band pass filter 427 and a weighting component 473). Accordingly, in some aspects, each band may be associated with a different weight which may provide an additional degree of freedom for optimizing an Rx analog precoding and/or antenna (or Rx chain) selection. While a particular antenna architecture has been presented in diagram 400, other architectures may be used in association with aspects of the disclosure.

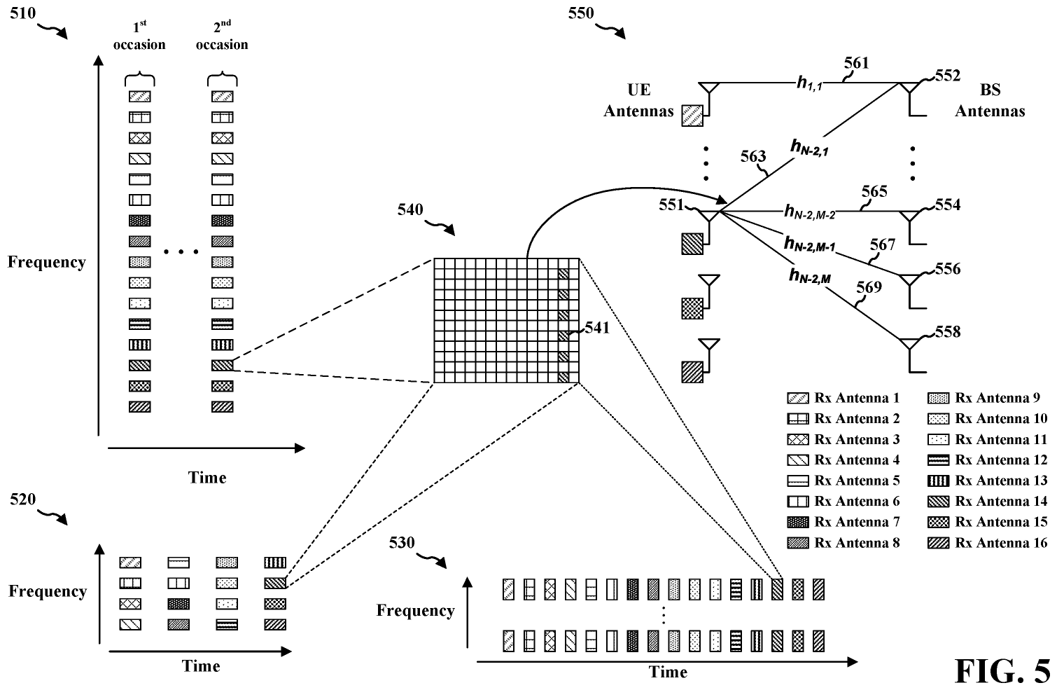

A network device (e.g., a base station), in some aspects, may have knowledge of the full channel, a channel from each of the Tx antennas of the network device to each of the analog Rx antennas of a UE. FIG. 5 is a set of diagrams illustrating aspects of determining the channel between each Tx antenna of a network device and each RX antenna of a UE in accordance with some aspects of the disclosure. While antennas at the network device may be referred to as Tx antennas and the antennas at the UE (or other wireless device) may be referred to as Rx antennas, it is understood that the antennas may be used for either transmission or reception at different times in association with aspects of the disclosure. Furthermore, the channel between the antennas at the network device and the antennas at the UE, in some aspects, may be determined based on transmissions from either the antennas of the network device or the antennas of the UE as the channel is assumed to be independent of the direction of signal propagation.

Diagram 550 illustrates a simplified view of a set of N UE antennas (where for illustrative purposes N is equal to 16) and a corresponding set of M antennas of a network device (e.g., a base station). Diagram 550 further illustrates a set of channels associated with the UE antennas and the antennas of the network device. For example, diagram 550 illustrates a (component) channel 561 (e.g., a channel h_{1,1}) between a first antenna of the UE and a first antenna 552 of the network device and a set of (component) channels between an (N−2)^{th} UE antenna 551 (e.g., a 14^{th} UE antenna) and each of the antennas of the network device (e.g., channel 563 (h_{N-2,1}) associated with antenna 552, channel 565 (h_{N-2,M-2}) associated with antenna 554, channel 567 (h_{N-2,M-1}) associated with antenna 556, and channel 569 (h_{N-2,M}) associated with antenna 558). The full channel (H) may then be determined based on the (component) channels 561, 563, 565, 567, and 569 and other (component) channels for each of the other combinations of UE antenna and antenna of the network device (e.g., the set of component channels h_{i,j} for i∈(1, N) and j∈(1, M)).

In some aspects, the determination of the set of the (component) channels between the UE antenna and each of the M antennas of the network device may include transmitting a reference signal (e.g., an SRS or similar reference signal) from each of the N UE antennas in such a way that the network device can separately determine and/or identify the contribution from each UE antenna at each antenna of the network device. For example, diagram 510 illustrates that the different antennas may be associated with different frequencies where the individual blocks in diagram 510 may represent an RB (e.g., 12 subcarriers in frequency and one slot in time, where diagram 540 illustrates the REs, such as RE 541, of the RB associated with a transmission of the SRS or other reference signal). Alternatively, the individual blocks in diagram 510 may represent a subcarrier in frequency and a symbol in time. Diagram 510 illustrates that the transmission of the reference signals may be repeated (e.g., repeated periodically or based on triggering event).

Diagram 530 illustrates that the different antennas may be associated with different times where the individual blocks in diagram 530 may represent an RB (e.g., 12 subcarriers in frequency and one slot in time, where diagram 540 illustrates the REs, such as RE 541, of the RB associated with a transmission of the SRS or other reference signal). Alternatively, the individual blocks in diagram 530 may represent a subcarrier in frequency and a symbol in time. Diagram 530 illustrates that the transmission of the reference signals may be repeated over multiple frequencies to determine a full channel.

Diagram 520, illustrates a combination of the frequency-based identification and the time-based identification where each antenna is associated with a specific frequency and time where the individual blocks in diagram 520 may represent an RB (e.g., 12 subcarriers in frequency and one slot in time, where diagram 540 illustrates the REs, such as RE 541, of the RB associated with a transmission of the SRS or other reference signal). Alternatively, the individual blocks in diagram 520 may represent a subcarrier in frequency and a symbol in time. While the different diagrams 510, 520, and 530 illustrate transmissions from different antennas that use (or are associated with) resources that may appear contiguous (or close) in frequency and/or time, this is merely for compact illustration and, in some aspects, the resources in frequency and/or time associated with different antennas may be non-contiguous (or sufficiently separated) in frequency and/or time to enable the reference signals from different antennas to be distinguished at the antennas of the network device.

Various aspects relate generally to analog reception combining (e.g., via Rx analog combining). Some aspects more specifically relate to a multi-antenna transmitting device (e.g., a network device) and/or a multi-antenna receiving device (e.g., a UE) associated with an Rx antenna analog precoding and/or selection based on the knowledge of the full channel between the transmitting device and the receiving device. In some examples, the UE may be configured to obtain a configuration for an antenna identification associated with a plurality of antennas at the UE. The UE may further be configured to output, for a network device and based on the configuration for the antenna identification, a set of antenna identification signals and obtain, based on the set of antenna identification signals, analog reception combining information. The UE may also be configured to communicate with the network device based on the analog reception combining information. In some examples, the network device may be configured to output a configuration for an antenna identification associated with a plurality of antennas at a UE. The network device may further be configured to obtain, from the UE and based on the configuration for the antenna identification, a set of antenna identification signals and output, based on the set of antenna identification signals, analog reception combining information. The network device may also be configured to communicate with the UE based on the analog reception combining information.

Some aspects may include a joint Tx precoding along with an Rx analog precoding and/or antenna selection based on the knowledge of the full channel. For example, based on the knowledge of the full channel, a network device (e.g., a base station) may perform an optimal joint Tx precoding and Rx analog precoding and/or antenna selection at the UE. In some aspects, the UE may have one or more analog band pass filters, at which the weights of each band can be controlled separately thereby increasing the degrees of freedom of the analog precoding. The Rx analog precoding and/or antenna selection, in some aspects, may be implemented to mitigate the increased power consumption associated with the use of a large number of antennas (and associated Rx chains). Accordingly, based on the Rx analog precoding and/or antenna (or Rx chain) selection, a relatively small number of full Rx chains may be maintained and/or used at the UE in association with a particular communication. This allows significant UE power consumption reduction, with minimal capacity loss.

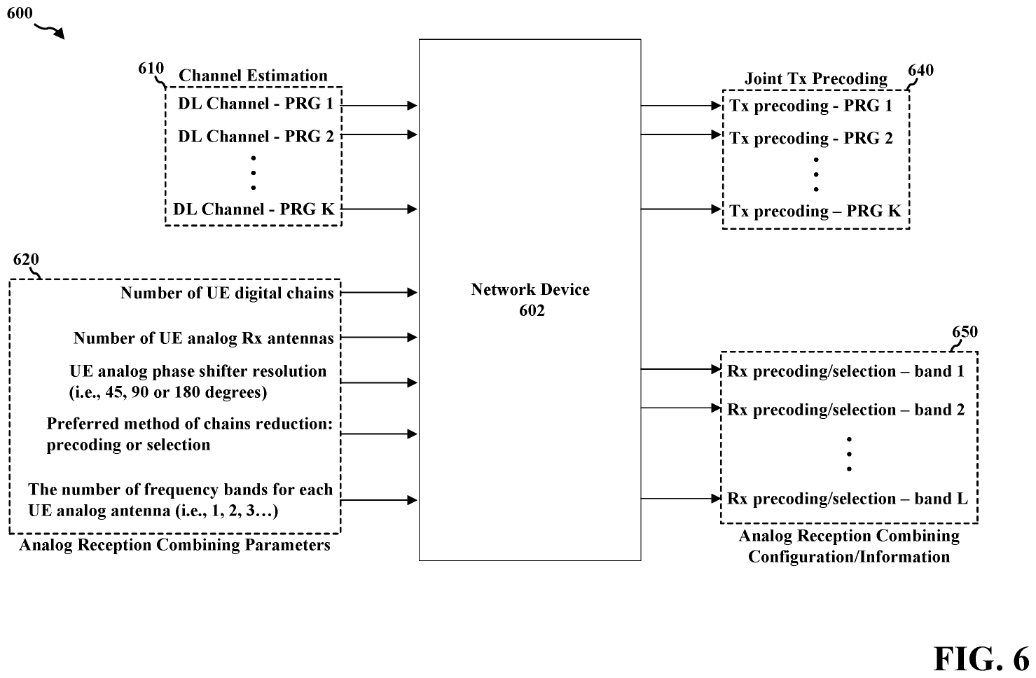

FIG. 6 is a diagram 600 illustrating a set of inputs and outputs associated with Rx analog precoding and/or antenna selection in accordance with some aspects of the disclosure. For example, a network device 602 may receive channel estimation information 610 regarding a (DL) channel associated with each precoding resource block group (PRG) of a set of K PRGs used (or potentially used) for communication with a UE. The channel estimation information 610, in some aspects, may be based on the reference signals transmitted by the UE as discussed in relation to FIG. 5.

The network device 602, in some aspects, may also receive information regarding a set of one or more parameters associated with analog Rx combining 620 (e.g., parameters that may be used to determine an optimal Rx analog precoding and/or Rx antenna (or Rx chain) selection). For example, the set of one or more parameters associated with analog Rx combining 620 may include information regarding a first number of analog processing chains at the UE (e.g., analog chains in the set of analog Rx chains 410), a second number (e.g., smaller than the first number) of digital processing chains (e.g., digital Rx chain 451 to 453), a preference for analog Rx precoding or antenna (or Rx chain) selection to reduce the power associated with processing a received signal, a resolution of a phase shifter (e.g., indicated as degrees or an integer by which to divide a reference phase shift such as 360 degrees) at the UE (e.g., a resolution of a phase shift applied by a weighting component 431 to 437), a resolution of an amplitude adjustment (e.g., a resolution of an amplitude adjustment, e.g., steps of 3 dB, 6 dB or reductions by ½, or ¼, applied by a weighting component) and a fifth (maximum) number of frequency bands (e.g., L frequency bands) associated with each antenna (e.g., the number of band pass filters that may be applied to a received signal).

Based on the input information (e.g., the channel estimation information 610 and the set of one or more parameters associated with analog Rx combining 620), the network device 602 may determine an optimal Tx joint precoding 640 for each of the K PRGs used for communication with the UE and analog reception combining configuration and/or information 650 for each of a set of L bands used for communication with the UE. The analog reception combining configuration and/or information 650 for each band of the set of L bands may indicate a set of precoding weights associated with each antenna (or each selected antenna and/or Rx chain) (e.g., weights applied to the received signal via each antenna and/or Rx chain). In some aspects, the selection of an antenna and/or Rx chain may be indicated by an associated (or corresponding) Rx precoding weight of 0 or by a set of bits indicating whether each of a set of antennas (e.g., a set including all the antennas of the UE or a subset of antennas used for a particular communication) is selected. For example, a set of selected antennas and/or Rx chains (e.g., combinations of analog and digital Rx chains) may be indicated using a bitmap including a number of bits equal to the number of antennas in the set of antennas (e.g., candidate antennas) or using bits indicating a set of antennas and/or Rx chains that are selected or not selected (where the decision to use one of the methods may be based on an expected signaling overhead associated with each type of indication). In some aspects, the reduction in analog Rx chains may result in an association of each antenna and/or analog Rx chains with a particular digital Rx chain.

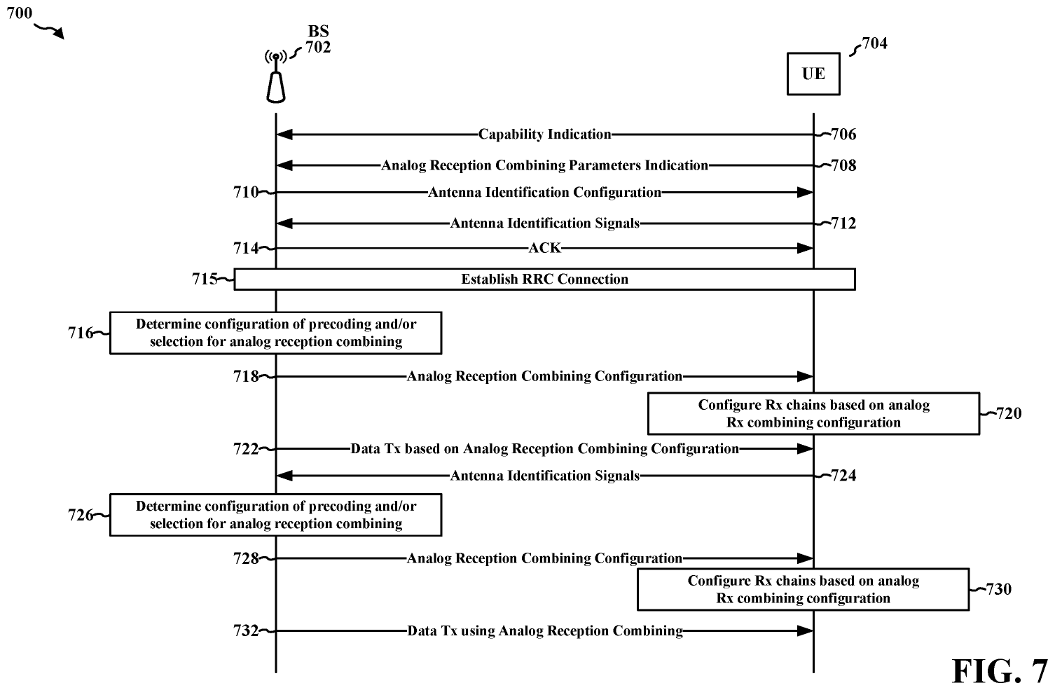

FIG. 7 is a call flow diagram 700 illustrating a method of wireless communication associated with analog reception combining in accordance with some aspects of the disclosure. The method is illustrated in relation to a base station 702 (e.g., as an example of a network device or network node that may include one or more components of a disaggregated base station) in communication with a UE 704 (e.g., as an example of a wireless device). The functions ascribed to the base station 702, in some aspects, may be performed by one or more components of a network entity, a network node, or a network device (a single network entity/node/device or a disaggregated network entity/node/device as described above in relation to FIG. 1). Similarly, the functions ascribed to the UE 704, in some aspects, may be performed by one or more components of a wireless device supporting communication with a network entity/node/device. Accordingly, references to “transmitting” in the description below may be understood to refer to a first component of the base station 702 (or the UE 704) outputting (or providing) an indication of the content of the transmission to be transmitted by a different component of the base station 702 (or the UE 704). Similarly, references to “receiving” in the description below may be understood to refer to a first component of the base station 702 (or the UE 704) receiving a transmitted signal and outputting (or providing) the received signal (or information based on the received signal) to a different component of the base station 702 (or the UE 704).

The UE 704, in some aspects, may transmit, and the base station 702 may receive, a capability indication 706 of support for analog reception combining (and/or selection). In association with, or based on transmitting, the capability indication 706, the UE 704 may transmit, and the base station 702 may receive, an analog reception combining parameters indication 708 including information regarding a set of one or more parameters that the base station 702 may use to determine an optimal analog Rx combining and/or antenna (or Rx chain) selection. In some aspects, the information included in the analog reception combining parameters indication 708 may also be used to determine a joint Tx precoding to be applied at the base station 702 in association with the analog Rx combining and/or antenna (or Rx chain) selection. As an example, the UE may indicate one or more of the following parameters in the message, e.g., at 708: number of analog receive chains, a number of digital receive chains (that may be less than the number of analog receive chains), a particular method for chain reduction (e.g., precoding or selection, which may be referred to as a chain reduction preference), a phase shifter resolution (e.g., 45 degrees, 90 degrees, 180 degrees, among other examples), a resolution of an amplitude adjustment, and/or a number of frequency bands for each antenna (e.g., 1 band, 2 bands, 3 bands, among other examples). In some aspects, for analog precoding, the combining may be based on phase shifters. The network may respond to the UE with an ACK and/or parameters for UE Rx identification, e.g., such as an allocation of time resources (e.g., slots) and/or an allocation of frequency resources (e.g., RBs) for the UE to send a signal for Rx antenna identification.

Based on the capability indication 706 and/or the analog reception combining parameters indication 708, the base station 702 may transmit, and the UE 704 may receive, an antenna identification configuration 710. The antenna identification configuration 710, in some aspects, may indicate a method for uniquely identifying and/or determining reference signals transmitted from each antenna of the UE 704. For example, the antenna identification configuration 710 may include one or more of a first allocation of at least one frequency resource for each antenna of the plurality of antennas, an allocation of at least one time resource for each antenna of the plurality of antennas, and a code associated with each antenna of the plurality of antennas. For example, each antenna of a group of 16 antennas of a UE may be allocated one of the resources illustrated in any of the diagram 510, 520, or 530 and, if there are multiple groups of 16 antennas, each group may use a same set of resources (e.g., a same set of RBs or REs) while being associated with a different code that can be used to distinguish the signal from two antennas transmitting a reference signal via a same resource (e.g., a same RB or RE).

Based on the antenna identification configuration 710, the UE 704 may transmit, and the base station 702 may receive, a set of antenna identification signals 712. The set of antenna identifications, in some aspects, may include a set of reference signals as described in relation to FIG. 5. For example, the UE may transmit from a first antenna (e.g., antenna 0) in a first OFDM symbol, transmit from a second antenna (e.g., antenna 1) in a second OFDM symbol, and continuing until the UE has transmitted from each of the antennas. Based on receiving the set of antenna identification signals 712, the base station 702 may transmit, and the UE 704 may receive, an ACK 714). At 715, the base station 702 and the UE 704 may establish an RRC connection. In some aspects, after an RRC connection is established, the base station may send a message, such as a DCI to the UE with the updated Rx analog precoding weights or selection.

At 716, the base station 702 may determine an optimized configuration for an Rx analog precoding and/or antenna (or Rx chain) selection for the analog Rx combining. In some aspects, the optimization may optimize for power consumption while maintaining a threshold throughput. For example, the number of digital chains after optimization may represent a minimal number of digital chains that can support a threshold throughput. The determination, in some aspects, may be based on the analog reception combining parameters indication 708 and the antenna identification signals 712 (or other related reference signals) used to determine the channel between each of the antennas of the base station 702 and each of the antennas of the UE 704 (e.g., each of the h_{i,j} for i∈(1, N) and j∈(1, M), where N is the number of antennas at the UE 704 and M is the number of antennas at the base station 702). The configuration for the analog Rx combining determined at 716, in some aspects, may include a per-band configuration for multiple bands supported by the Rx chains (e.g., as indicated in the analog reception combining parameters indication 708). In some aspects, the determination at 716 may further include determining an optimized joint Tx precoding (e.g., for each PRG) to be applied at the base station 702 that may, or may not be, made known to the UE 704.

Based on the determination at 716, the base station 702 may transmit, and the UE 704 may receive, an analog Rx combining configuration 718. The analog Rx combining configuration 718, in some aspects, may be transmitted via DCI. In some aspects, the analog Rx combining configuration 718 may indicate a set of Rx analog precoding weights (e.g., in the DCI). In some aspects, the set of Rx analog precoding weights may include multiple weights for each antenna with each weight corresponding to a particular frequency band for the antenna (e.g., associated with a signal received via the particular frequency band).

The set of Rx analog precoding weights, in some aspects, may indicate an antenna and/or Rx chain selection via a set of either zero or non-zero weights, where a weight of 0 indicates an unselected antenna and/or Rx chain and a non-zero weight indicates a selected antenna and/or Rx chain. In some aspects, the indication of the selection of the antennas and/or Rx chains may be via a bitmap corresponding to the antennas and/or Rx chains, or via a set of one or more indices of selected (or unselected) antennas and/or Rx chains. The type of indication of the selected antennas and/or Rx chains may be determined dynamically and indicated in a field of the DCI or may be known to the base station 702 and the UE 704 (e.g., one of the bitmap, the indication of selected antennas and/or Rx chains, or the indication unselected antennas and/or Rx chains may be determined to be associated with a smallest expected overhead and implemented in a static manner).

Based on the analog Rx combining configuration 718, the UE 704 may, at 720, configure the related set of Rx chains for communication with the base station 702. The base station may transmit, and the UE 704 may receive, a data transmission 722 based on the analog reception combining configuration 718. Receiving the data transmission 722 at the UE 704 may include processing the received signals based on the analog reception combining configuration 718 (e.g., applying the Rx analog precoding weights and or the antenna (or Rx chain) selection).

In the course of normal operation, the UE 704 may transmit, and the base station 702 may receive, an additional set of antenna identification signals 724 (e.g., for updating a channel estimation). The transmission of the additional set of antenna identification signals 724, in some aspects, may be transmitted based on a period associated with transmitting reference signals (e.g., based on an SRS configuration). In some aspects, the additional set of antenna identification signals 724 may be transmitted based on a triggering event detected at one of the base station 702 or at the UE 704 (e.g., an error rate crossing a threshold that indicates that the channel estimation may no longer be valid).

In some aspects, the update rate of the precoding may depend on the update rate of the DL channel estimation at the base station 702. The DL channel is updated at the UL SRS rate. So, in some aspects, the precoding may be updated at the SRS rate. Additionally, in some aspects, the UE 704 may also transmit a CSI report that includes a recommended MCS, rank, and precoding matrix index from a pre-defined codebook. The CSI report, in some aspects, may result also in an update to the precoding.

At 726, the base station 702 may determine an (updated) optimized configuration for an Rx analog precoding and/or antenna (or Rx chain) selection for the analog Rx combining. The determination, in some aspects, may be based on the analog reception combining parameters indication 708 and the additional set of antenna identification signals 724 (or other related reference signals) used to determine the (updated) channel between each of the antennas of the base station 702 and each of the antennas of the UE 704 (e.g., each of the h_{i,j} for i∈(1, N) and j∈(1, M), where N is the number of antennas at the UE 704 and M is the number of antennas at the base station 702). The (updated) configuration for the analog Rx combining determined at 726, in some aspects, may include a per-band configuration for multiple bands supported by the Rx chains (e.g., as indicated in the analog reception combining parameters indication 708). In some aspects, the determination at 726 may further include determining an (updated) optimized joint Tx precoding (e.g., for each PRG) to be applied at the base station 702 that may, or may not be, made known to the UE 704.

Based on the determination at 726, the base station 702 may transmit, and the UE 704 may receive, an (updated or additional) analog Rx combining configuration 728. The analog Rx combining configuration 728, in some aspects, may be transmitted via DCI and may be formatted as described in relation to the analog Rx combining configuration 718. In some aspects, the analog Rx combining configuration 728 may indicate an updated set of Rx analog precoding weights (e.g., in the DCI). In some aspects, the updated set of Rx analog precoding weights may be indicated by a set of differential weights used to update the set of Rx analog precoding weights indicated in Rx combining configuration 718.

Based on the analog Rx combining configuration 728, the UE 704 may, at 730, configure the related set of Rx chains for communication with the base station 702. The base station may transmit, and the UE 704 may receive, a data transmission 732 based on the analog reception combining configuration 728. Receiving the data transmission 722 at the UE 704 may include processing the received signals based on the analog reception combining configuration 728 (e.g., applying the Rx analog precoding weights and or the antenna (or Rx chain) selection).

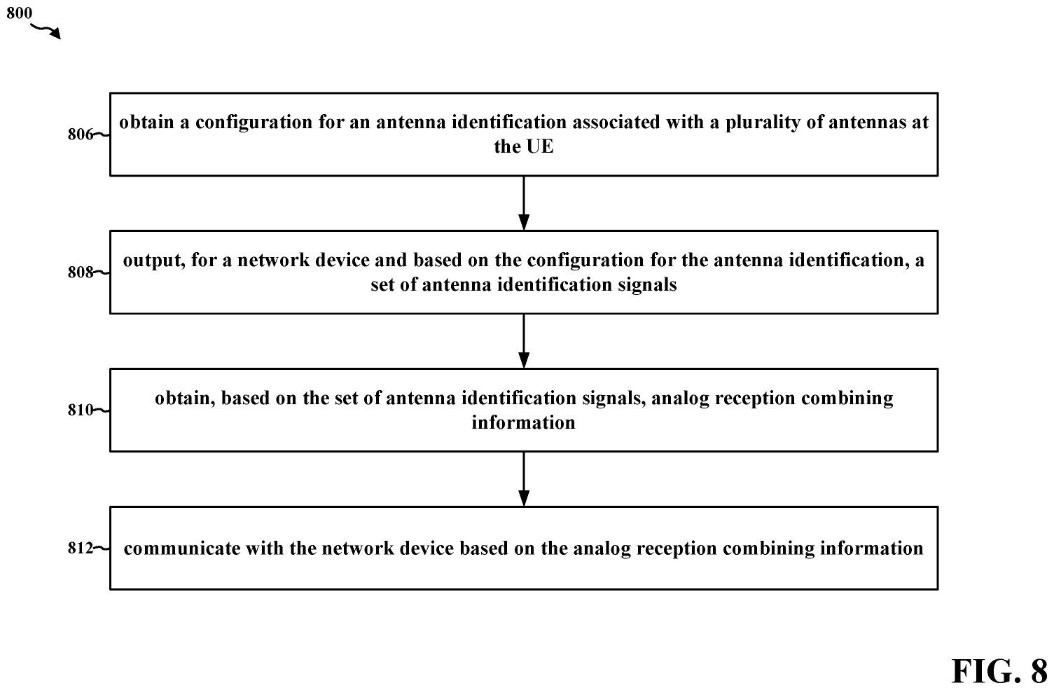

FIG. 8 is a flowchart 800 of a method of wireless communication. The method may be performed by a UE or other wireless device (e.g., the UE 104, 704; the apparatus 1204). In some aspects, the UE may output a capability indication of support for an analog reception combining. and a set of one or more parameters related to the analog reception combining. The set of one or more parameters related to the analog reception combining, in some aspects, may include one or more of a first number of analog processing chains at the UE, a second number of digital processing chains at the UE (where the first number of analog processing chains may be greater than the second number of digital processing chains), whether a precoding method or a selection method is a desired method for reducing at least one of a third number of analog processing chains or a fourth number of digital processing chains in association with the analog reception combining, a resolution of a phase shifter at the UE, a resolution of an amplitude adjustment, or a fifth number of bands (and the corresponding frequencies) associated with each of the plurality of antennas associated with the UE. For example, referring to FIGS. 6 and 7, the UE 704 may transmit the capability indication 706 of support for analog reception combining (and/or selection) and the analog reception combining parameters indication 708 (e.g., the set of one or more parameters associated with analog Rx combining 620).

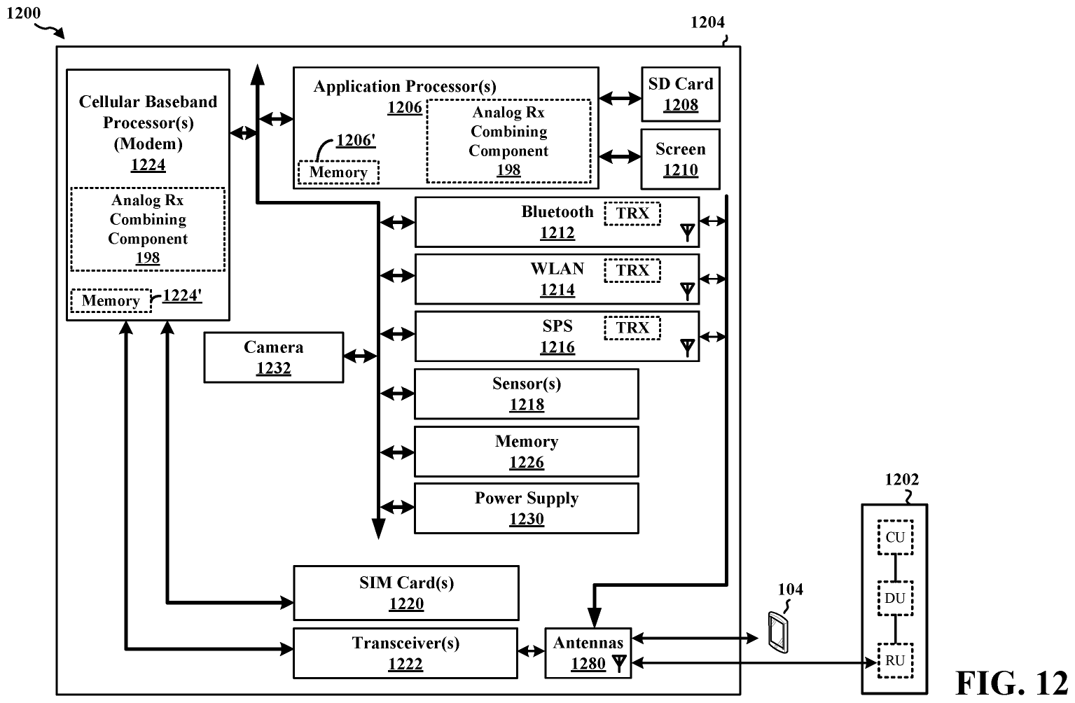

At 806, the UE may obtain a configuration for an antenna identification associated with a plurality of antennas at the UE. For example, 806 may be performed by application processor(s) 1206, cellular baseband processor(s) 1224, transceiver(s) 1222, antenna(s) 1280, and/or analog Rx combining component 198 of FIG. 12. The configuration, in some aspects may be based on at least one of the capability indication or the set of one or more parameters related to the analog reception combining. In some aspects, the configuration for the antenna identification includes one or more of a third indication of a first allocation of at least one frequency resource for each antenna of the plurality of antennas, a fourth indication of a second allocation of at least one time resource for each antenna of the plurality of antennas, or a fifth indication of a code associated with each antenna of the plurality of antennas. The configuration for the antenna identification, in some aspects, may generally indicate a resource allocation that allows the network device to distinguish reference signals from the different antennas of the UE. For example, referring to FIGS. 6 and 7, the UE 704 may receive the antenna identification configuration 710 (e.g., the analog reception combining configuration and/or information 650).

At 808, the UE may output, for a network device and based on the configuration for the antenna identification, a set of antenna identification signals. In some aspects, the set of antenna identification signals may include a plurality of reference signals (e.g., SRS) associated with a corresponding antenna in the plurality of antennas. Outputting the set of antenna identification signals, in some aspects, may include transmitting each of the plurality of reference signals via the corresponding antenna via the at least one frequency resource and the at least one time resource for the corresponding antenna. For example, 808 may be performed by application processor(s) 1206, cellular baseband processor(s) 1224, transceiver(s) 1222, antenna(s) 1280, and/or analog Rx combining component 198 of FIG. 12. Referring to FIGS. 6 and 7, for example, the UE 704 may transmit the set of antenna identification signals 712 (that may be used to determine the channel estimation information 610).

At 810, the UE may obtain, based on the set of antenna identification signals, analog reception combining information. For example, 810 may be performed by application processor(s) 1206, cellular baseband processor(s) 1224, transceiver(s) 1222, antenna(s) 1280, and/or analog Rx combining component 198 of FIG. 12. In some aspects, the analog reception combining information may be received via DCI. The analog reception combining information, in some aspects, indicates at least one of a selection of a subset of antennas of the plurality of antennas at the UE or a set of weights (e.g., a phase shift or multiplicative value) associated with each antenna of the plurality of antennas at the UE. In some aspects, the set of weights associated with a first (or each) antenna of the plurality of antennas at the UE includes a plurality of weights corresponding to a plurality of frequency bands associated with the first (or each) antenna. The selection of a subset of antennas of the plurality of antennas at the UE, in some aspects, may be indicated using one of a bitmap associated with the plurality of antennas at the UE or a set of indices associated with one of the selected or unselected antennas of the plurality of antennas at the UE. For example, referring to FIG. 7, the UE 704 may receive the analog Rx combining configuration 718.

At 812, the UE may communicate with the network device based on the analog reception combining information. For example, 812 may be performed by application processor(s) 1206, cellular baseband processor(s) 1224, transceiver(s) 1222, antenna(s) 1280, and/or analog Rx combining component 198 of FIG. 12. Communicating with the network device, in some aspects, may include configuring a set of Rx chains for communication with the network device based on the analog reception combining information. In some aspects, the communication may include receiving a DL transmission from the network device that is processed based on the analog reception combining information. For example, referring to FIG. 7, the UE 704 may receive the data transmission 722 based on configuring the set of Rx chains at 720. As described in relation to FIG. 7, the method may periodically (or based on a triggering event) return to 808 to output an additional set of antenna identification signals, obtain updated analog reception combining information, and communicate with the network device based on the updated analog reception combining information.

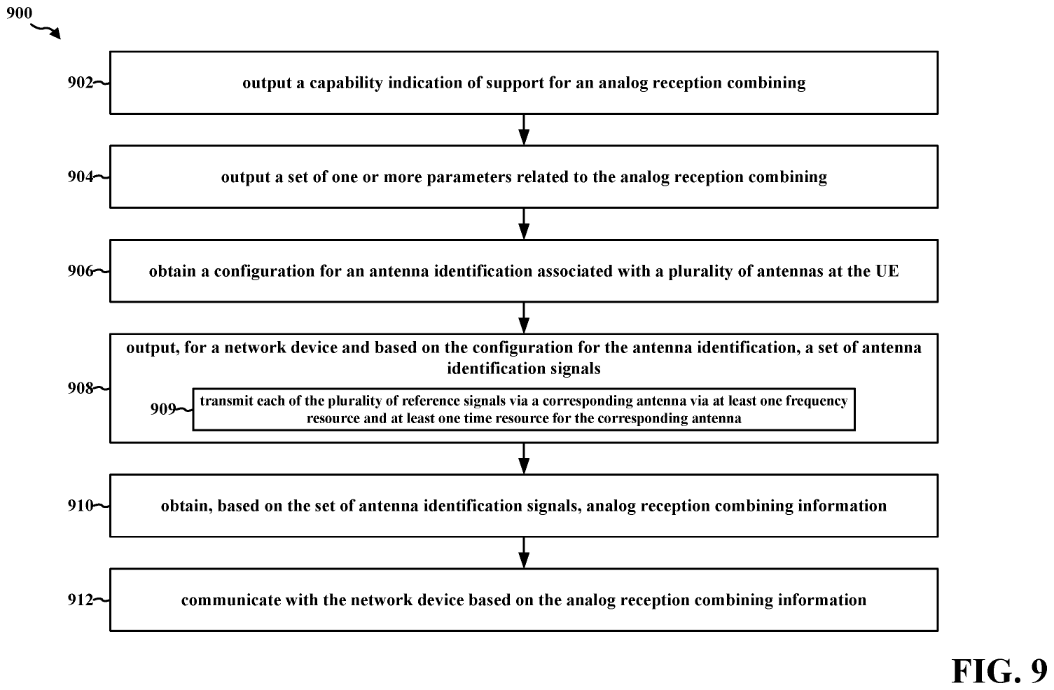

FIG. 9 is a flowchart 900 of a method of wireless communication. The method may be performed by a UE or other wireless device (e.g., the UE 104, 704; the apparatus 1204). At 902, the UE may output a capability indication of support for an analog reception combining. For example, 902 may be performed by application processor(s) 1206, cellular baseband processor(s) 1224, transceiver(s) 1222, antenna(s) 1280, and/or analog Rx combining component 198 of FIG. 12. Referring to FIG. 7, for example, the UE 704 may transmit capability indication 706 of support for analog reception combining (and/or selection).

At 904, the UE may output a set of one or more parameters related to the analog reception combining. For example, 904 may be performed by application processor(s) 1206, cellular baseband processor(s) 1224, transceiver(s) 1222, antenna(s) 1280, and/or analog Rx combining component 198 of FIG. 12. In some aspects, the set of one or more parameters related to the analog reception combining may include one or more of a first number of analog processing chains at the UE, a second number of digital processing chains at the UE (where the first number of analog processing chains may be greater than the second number of digital processing chains), whether a precoding method or a selection method is a desired method for reducing at least one of a third number of analog processing chains or a fourth number of digital processing chains in association with the analog reception combining, a resolution of a phase shifter at the UE, a resolution of an amplitude adjustment, or a fifth number of bands (and the corresponding frequencies) associated with each of the plurality of antennas associated with the UE. For example, referring to FIGS. 6 and 7, the UE 704 may transmit the analog reception combining parameters indication 708 (e.g., the set of one or more parameters associated with analog Rx combining 620).

At 906, the UE may obtain a configuration for an antenna identification associated with a plurality of antennas at the UE. For example, 906 may be performed by application processor(s) 1206, cellular baseband processor(s) 1224, transceiver(s) 1222, antenna(s) 1280, and/or analog Rx combining component 198 of FIG. 12. The configuration, in some aspects may be based on at least one of the capability indication or the set of one or more parameters related to the analog reception combining. In some aspects, the configuration for the antenna identification includes one or more of a third indication of a first allocation of at least one frequency resource for each antenna of the plurality of antennas, a fourth indication of a second allocation of at least one time resource for each antenna of the plurality of antennas, or a fifth indication of a code associated with each antenna of the plurality of antennas. The configuration for the antenna identification, in some aspects, may generally indicate a resource allocation that allows the network device to distinguish reference signals from the different antennas of the UE. For example, referring to FIGS. 6 and 7, the UE 704 may receive the antenna identification configuration 710 (e.g., the analog reception combining configuration and/or information 650).

At 908, the UE may output, for a network device and based on the configuration for the antenna identification, a set of antenna identification signals. In some aspects, the set of antenna identification signals may include a plurality of reference signals (e.g., SRS) associated with a corresponding antenna in the plurality of antennas. Outputting the set of antenna identification signals, in some aspects, may include transmitting, at 909, each of the plurality of reference signals via the corresponding antenna via the at least one frequency resource and the at least one time resource for the corresponding antenna. For example, 908 and 909 may be performed by application processor(s) 1206, cellular baseband processor(s) 1224, transceiver(s) 1222, antenna(s) 1280, and/or analog Rx combining component 198 of FIG. 12. Referring to FIGS. 6 and 7, for example, the UE 704 may transmit the set of antenna identification signals 712 (that may be used to determine the channel estimation information 610) based on the antenna identification configuration 710.

At 910, the UE may obtain, based on the set of antenna identification signals, analog reception combining information. For example, 910 may be performed by application processor(s) 1206, cellular baseband processor(s) 1224, transceiver(s) 1222, antenna(s) 1280, and/or analog Rx combining component 198 of FIG. 12. In some aspects, the analog reception combining information may be received via DCI. The analog reception combining information, in some aspects, indicates at least one of a selection of a subset of antennas of the plurality of antennas at the UE or a set of weights (e.g., a phase shift or multiplicative value) associated with each antenna of the plurality of antennas at the UE. In some aspects, the set of weights associated with a first (or each) antenna of the plurality of antennas at the UE includes a plurality of weights corresponding to a plurality of frequency bands associated with the first (or each) antenna. The selection of a subset of antennas of the plurality of antennas at the UE, in some aspects, may be indicated using one of a bitmap associated with the plurality of antennas at the UE or a set of indices associated with one of the selected or unselected antennas of the plurality of antennas at the UE. For example, referring to FIG. 7, the UE 704 may receive the analog Rx combining configuration 718.

At 912, the UE may communicate with the network device based on the analog reception combining information. For example, 912 may be performed by application processor(s) 1206, cellular baseband processor(s) 1224, transceiver(s) 1222, antenna(s) 1280, and/or analog Rx combining component 198 of FIG. 12. Communicating with the network device, in some aspects, may include configuring a set of Rx chains for communication with the network device based on the analog reception combining information. In some aspects, the communication may include receiving a DL transmission from the network device that is processed based on the analog reception combining information. For example, referring to FIG. 7, the UE 704 may receive the data transmission 722 based on configuring the set of Rx chains at 720. As described in relation to FIG. 7, the method may periodically (or based on a triggering event) return to 908 to output an additional set of antenna identification signals, obtain updated analog reception combining information, and communicate with the network device based on the updated analog reception combining information.

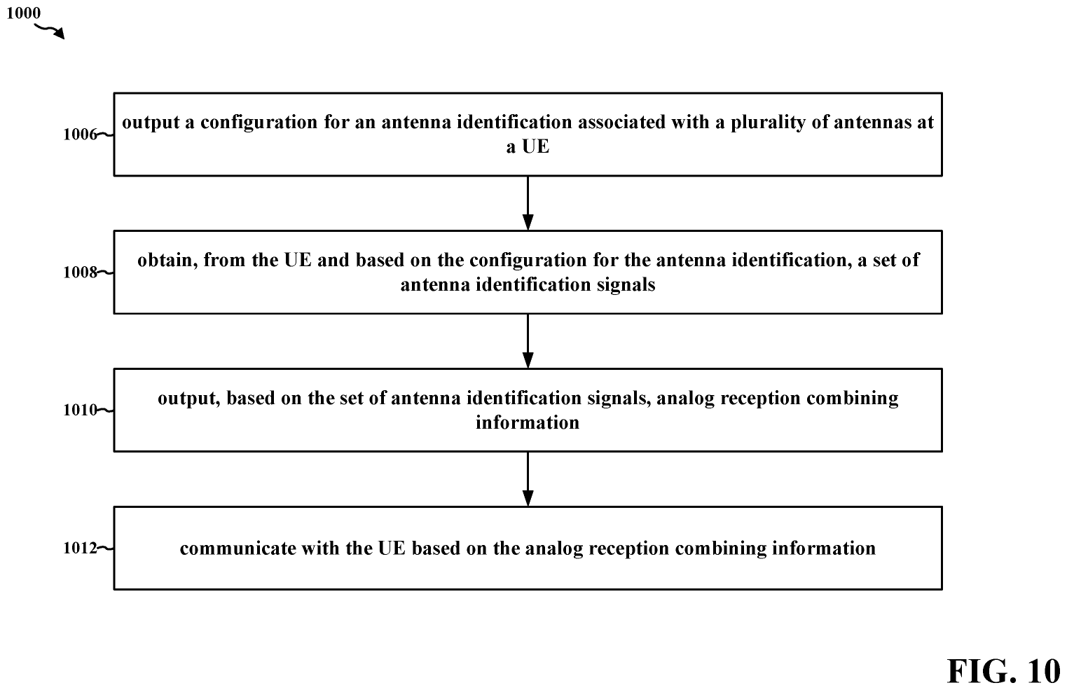

FIG. 10 is a flowchart 1000 of a method of wireless communication. The method may be performed by a network device such as a base station (e.g., the base station 102, 702; the network device 602; the network entity 1202, 1302). In some aspects, the network device may obtain a capability indication of support for an analog reception combining at a UE. Referring to FIG. 7, for example, the base station 702 may receive capability indication 706 of support for analog reception combining (and/or selection). The network device, in some aspects, may obtain a set of one or more parameters related to the analog reception combining. In some aspects, the set of one or more parameters related to the analog reception combining may include one or more of a first number of analog processing chains at the UE, a second number of digital processing chains at the UE (where the first number of analog processing chains may be greater than the second number of digital processing chains), whether a precoding method or a selection method is a desired method for reducing at least one of a third number of analog processing chains or a fourth number of digital processing chains in association with the analog reception combining, a resolution of a phase shifter at the UE, a resolution of an amplitude adjustment, or a fifth number of bands (and the corresponding frequencies) associated with each of the plurality of antennas associated with the UE. For example, referring to FIG. 7, the base station 702 may receive the analog reception combining parameters indication 708.

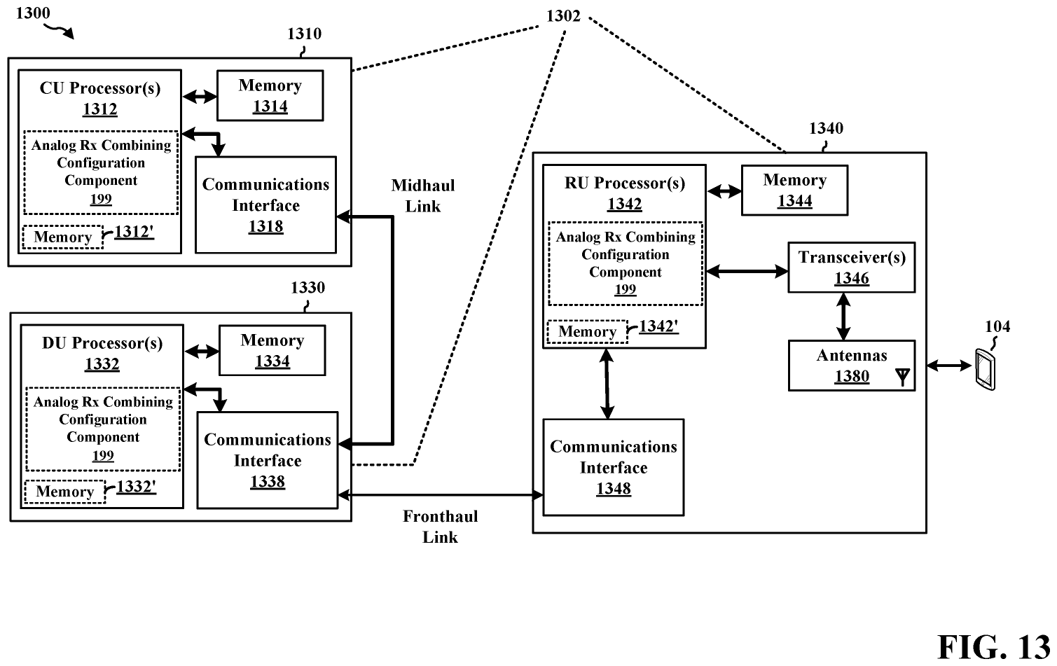

At 1006, the network device may output a configuration for an antenna identification associated with a plurality of antennas at the UE. For example, 1006 may be performed by CU processor(s) 1312, DU processor(s) 1332, RU processor(s) 1342, transceiver(s) 1346, antenna(s) 1380, and/or analog Rx combining configuration component 199 of FIG. 13. The configuration, in some aspects may be based on at least one of the capability indication or the set of one or more parameters related to the analog reception combining. In some aspects, the configuration for the antenna identification includes one or more of a third indication of a first allocation of at least one frequency resource for each antenna of the plurality of antennas, a fourth indication of a second allocation of at least one time resource for each antenna of the plurality of antennas, or a fifth indication of a code associated with each antenna of the plurality of antennas. The configuration for the antenna identification, in some aspects, may generally indicate a resource allocation that allows the network device to distinguish reference signals from the different antennas of the UE. For example, referring to FIG. 7, the base station 702 may transmit the antenna identification configuration 710.

At 1008, the network device may obtain, from the UE and based on the configuration for the antenna identification, a set of antenna identification signals. In some aspects, the set of antenna identification signals may include a plurality of reference signals (e.g., SRS) associated with a corresponding antenna in the plurality of antennas. The set of antenna identification signals, in some aspects, may include receiving each of the plurality of reference signals transmitted by the corresponding antenna via the at least one frequency resource and the at least one time resource for the corresponding antenna. For example, 1008 may be performed by CU processor(s) 1312, DU processor(s) 1332, RU processor(s) 1342, transceiver(s) 1346, antenna(s) 1380, and/or analog Rx combining configuration component 199 of FIG. 13. Referring to FIG. 7, for example, the base station 702 may receive the set of antenna identification signals 712 based on the antenna identification configuration 710.

In some aspects, the network device may determine an optimized analog reception combining information. The analog reception combining information, in some aspects, may include optimized analog Rx precoding weights, a selection of antennas (or Rx chains). In some aspects, the network device may further determine a joint Tx precoding for application at the network device in association with the analog reception combining information. For example, referring to FIGS. 6 and 7, the base station 702 (or network device 602) may, at 716 determine the analog Rx combining configuration 718 (or the optimal Tx joint precoding 640 and the analog reception combining configuration and/or information 650).

At 1010, the network device may output, based on the set of antenna identification signals, analog reception combining information. For example, 1010 may be performed by CU processor(s) 1312, DU processor(s) 1332, RU processor(s) 1342, transceiver(s) 1346, antenna(s) 1380, and/or analog Rx combining configuration component 199 of FIG. 13. In some aspects, the analog reception combining information may be transmit via, or included in, DCI. The analog reception combining information, in some aspects, indicates at least one of a selection of a subset of antennas of the plurality of antennas at the UE or a set of weights (e.g., a phase shift or multiplicative value) associated with each antenna of the plurality of antennas at the UE. In some aspects, the set of weights associated with a first (or each) antenna of the plurality of antennas at the UE includes a plurality of weights corresponding to a plurality of frequency bands associated with the first (or each) antenna. The selection of a subset of antennas of the plurality of antennas at the UE, in some aspects, may be indicated using one of a bitmap associated with the plurality of antennas at the UE or a set of indices associated with one of the selected or unselected antennas of the plurality of antennas at the UE. For example, referring to FIG. 7, the base station 702 may transmit the analog Rx combining configuration 718.

At 1012, the network device may communicate with the UE based on the analog reception combining information. For example, 1012 may be performed by CU processor(s) 1312, DU processor(s) 1332, RU processor(s) 1342, transceiver(s) 1346, antenna(s) 1380, and/or analog Rx combining configuration component 199 of FIG. 13. In some aspects, the communication may include transmitting a DL transmission from the network device that is processed at the UE based on the analog reception combining information. For example, referring to FIG. 7, the base station 702 may transmit the data transmission 722 based on the configuration determined at 716. As described in relation to FIG. 7, the method may periodically (or based on a triggering event) return to 1008 to obtain an additional set of antenna identification signals, output updated analog reception combining information, and communicate with the UE based on the updated analog reception combining information.

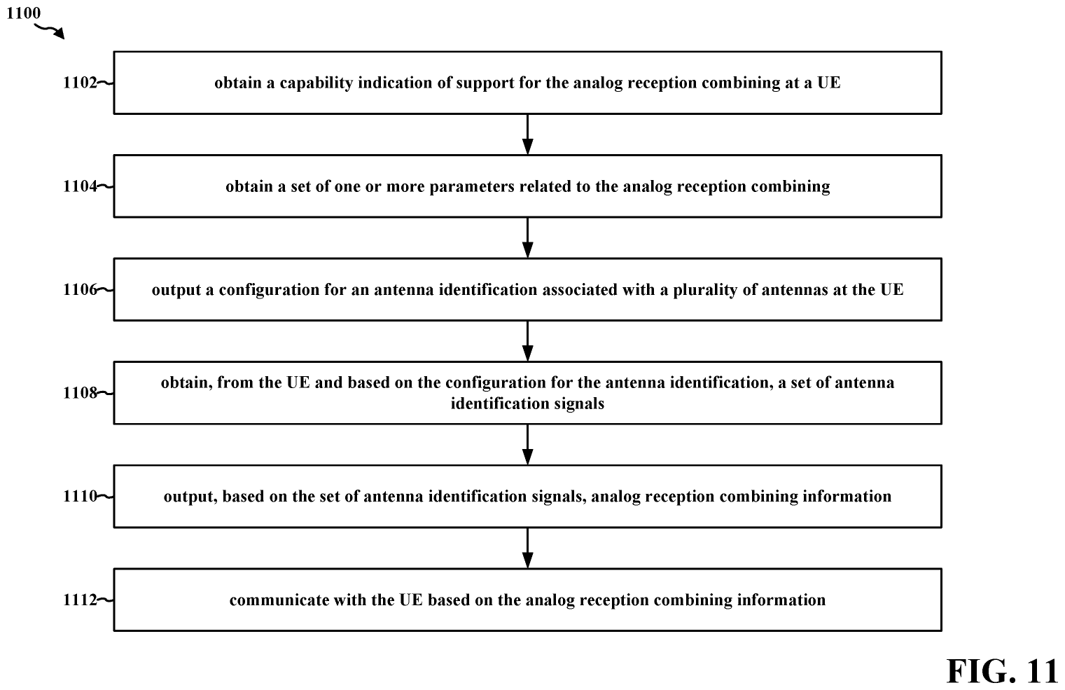

FIG. 11 is a flowchart 1100 of a method of wireless communication. The method may be performed by a network device such as a base station (e.g., the base station 102, 702; the network device 602; the network entity 1202, 1302). At 1102, the network device may obtain a capability indication of support for an analog reception combining at a UE. For example, 1102 may be performed by CU processor(s) 1312, DU processor(s) 1332, RU processor(s) 1342, transceiver(s) 1346, antenna(s) 1380, and/or analog Rx combining configuration component 199 of FIG. 13. Referring to FIG. 7, for example, the base station 702 may receive capability indication 706 of support for analog reception combining (and/or selection).

At 1104, the network device may obtain a set of one or more parameters related to the analog reception combining. For example, 1104 may be performed by CU processor(s) 1312, DU processor(s) 1332, RU processor(s) 1342, transceiver(s) 1346, antenna(s) 1380, and/or analog Rx combining configuration component 199 of FIG. 13. In some aspects, the set of one or more parameters related to the analog reception combining may include one or more of a first number of analog processing chains at the UE, a second number of digital processing chains at the UE (where the first number of analog processing chains may be greater than the second number of digital processing chains), whether a precoding method or a selection method is a desired method for reducing at least one of a third number of analog processing chains or a fourth number of digital processing chains in association with the analog reception combining, a resolution of a phase shifter at the UE, a resolution of an amplitude adjustment, or a fifth number of bands (and the corresponding frequencies) associated with each of the plurality of antennas associated with the UE. For example, referring to FIG. 7, the base station 702 may receive the analog reception combining parameters indication 708.

At 1106, the network device may output a configuration for an antenna identification associated with a plurality of antennas at the UE. For example, 1106 may be performed by CU processor(s) 1312, DU processor(s) 1332, RU processor(s) 1342, transceiver(s) 1346, antenna(s) 1380, and/or analog Rx combining configuration component 199 of FIG. 13. The configuration, in some aspects may be based on at least one of the capability indication or the set of one or more parameters related to the analog reception combining. In some aspects, the configuration for the antenna identification includes one or more of a third indication of a first allocation of at least one frequency resource for each antenna of the plurality of antennas, a fourth indication of a second allocation of at least one time resource for each antenna of the plurality of antennas, or a fifth indication of a code associated with each antenna of the plurality of antennas. The configuration for the antenna identification, in some aspects, may generally indicate a resource allocation that allows the network device to distinguish reference signals from the different antennas of the UE. For example, referring to FIG. 7, the base station 702 may transmit the antenna identification configuration 710.

At 1108, the network device may obtain, from the UE and based on the configuration for the antenna identification, a set of antenna identification signals. In some aspects, the set of antenna identification signals may include a plurality of reference signals (e.g., SRS) associated with a corresponding antenna in the plurality of antennas. The set of antenna identification signals, in some aspects, may include receiving each of the plurality of reference signals transmitted by the corresponding antenna via the at least one frequency resource and the at least one time resource for the corresponding antenna. For example, 1108 may be performed by CU processor(s) 1312, DU processor(s) 1332, RU processor(s) 1342, transceiver(s) 1346, antenna(s) 1380, and/or analog Rx combining configuration component 199 of FIG. 13. Referring to FIG. 7, for example, the base station 702 may receive the set of antenna identification signals 712 based on the antenna identification configuration 710.

In some aspects, the network device may determine an optimized analog reception combining information. The analog reception combining information, in some aspects, may include optimized analog Rx precoding weights, a selection of antennas (or Rx chains). In some aspects, the network device may further determine a joint Tx precoding for application at the network device in association with the analog reception combining information. For example, referring to FIGS. 6 and 7, the base station 702 (or network device 602) may, at 716 determine the analog Rx combining configuration 718 (or the optimal Tx joint precoding 640 and the analog reception combining configuration and/or information 650).

At 1110, the network device may output, based on the set of antenna identification signals, analog reception combining information. For example, 1110 may be performed by CU processor(s) 1312, DU processor(s) 1332, RU processor(s) 1342, transceiver(s) 1346, antenna(s) 1380, and/or analog Rx combining configuration component 199 of FIG. 13. In some aspects, the analog reception combining information may be transmit via, or included in, DCI. The analog reception combining information, in some aspects, indicates at least one of a selection of a subset of antennas of the plurality of antennas at the UE or a set of weights (e.g., a phase shift or multiplicative value) associated with each antenna of the plurality of antennas at the UE. In some aspects, the set of weights associated with a first (or each) antenna of the plurality of antennas at the UE includes a plurality of weights corresponding to a plurality of frequency bands associated with the first (or each) antenna. The selection of a subset of antennas of the plurality of antennas at the UE, in some aspects, may be indicated using one of a bitmap associated with the plurality of antennas at the UE or a set of indices associated with one of the selected or unselected antennas of the plurality of antennas at the UE. For example, referring to FIG. 7, the base station 702 may transmit the analog Rx combining configuration 718.

At 1112, the network device may communicate with the UE based on the analog reception combining information. For example, 1112 may be performed by CU processor(s) 1312, DU processor(s) 1332, RU processor(s) 1342, transceiver(s) 1346, antenna(s) 1380, and/or analog Rx combining configuration component 199 of FIG. 13. In some aspects, the communication may include transmitting a DL transmission from the network device that is processed at the UE based on the analog reception combining information. For example, referring to FIG. 7, the base station 702 may transmit the data transmission 722 based on the configuration determined at 716. As described in relation to FIG. 7, the method may periodically (or based on a triggering event) return to 1108 to obtain an additional set of antenna identification signals, output updated analog reception combining information, and communicate with the UE based on the updated analog reception combining information.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the analog Rx combining component 198 may be configured to obtain a configuration for an antenna identification associated with a plurality of antennas at the UE. The analog Rx combining component 198 may further be configured to output, for a network device and based on the configuration for the antenna identification, a set of antenna identification signals and obtain, based on the set of antenna identification signals, analog reception combining information. The analog Rx combining component 198 may also be configured to communicate with the network device based on the analog reception combining information. The analog Rx combining component 198 may be within the cellular baseband processor(s) 1224, the application processor(s) 1206, or both the cellular baseband processor(s) 1224 and the application processor(s) 1206. The analog Rx combining component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for obtaining a configuration for an antenna identification associated with a plurality of antennas at the UE. The apparatus 1204, and in particular the cellular baseband processor(s) 1224 and/or the application processor(s) 1206, may include means for outputting, for a network device and based on the configuration for the antenna identification, a set of antenna identification signals. The apparatus 1204, and in particular the cellular baseband processor(s) 1224 and/or the application processor(s) 1206, may include means for obtaining, based on the set of antenna identification signals, analog reception combining information. The apparatus 1204, and in particular the cellular baseband processor(s) 1224 and/or the application processor(s) 1206, may include means for communicating with the network device based on the analog reception combining information. The apparatus 1204, and in particular the cellular baseband processor(s) 1224 and/or the application processor(s) 1206, may include means for outputting a capability indication of support for the analog reception combining. The apparatus 1204, and in particular the cellular baseband processor(s) 1224 and/or the application processor(s) 1206, may include means for outputting a set of one or more parameters related to the analog reception combining. The apparatus 1204, and in particular the cellular baseband processor(s) 1224 and/or the application processor(s) 1206, may include means for transmitting each of the plurality of reference signals via the corresponding antenna via the at least one frequency resource and the at least one time resource for the corresponding antenna. The apparatus 1204, and in particular the cellular baseband processor(s) 1224 and/or the application processor(s) 1206, may include means for outputting, for the network device and based on the configuration for the antenna identification, an additional set of antenna identification signals. The apparatus 1204, and in particular the cellular baseband processor(s) 1224 and/or the application processor(s) 1206, may include means for obtaining, based on the set of antenna identification signals, updated analog reception combining information. The apparatus 1204, and in particular the cellular baseband processor(s) 1224 and/or the application processor(s) 1206, may include means for communicating with the network device based on the updated analog reception combining information. The apparatus 1204 may further include means for performing any of the aspects described in connection with the flowcharts in FIG. 8 or 9, and/or performed by the UE in the communication flow of FIG. 7. The means may be the analog Rx combining component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the analog Rx combining configuration component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the analog Rx combining configuration component 199 may be configured to output a configuration for an antenna identification associated with a plurality of antennas at a UE. The analog Rx combining configuration component 199 may further be configured to obtain, from the UE and based on the configuration for the antenna identification, a set of antenna identification signals and output, based on the set of antenna identification signals, analog reception combining information. The analog Rx combining configuration component 199 may also be configured to communicate with the UE based on the analog reception combining information. The analog Rx combining configuration component 199 may be within one or more processors of one or more of the CU 1310, DU 1330, and the RU 1340. The analog Rx combining configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for outputting a configuration for an antenna identification associated with a plurality of antennas at a UE. The network entity 1302, in some aspects, may include means for obtaining, from the UE and based on the configuration for the antenna identification, a set of antenna identification signals. The network entity 1302, in some aspects, may include means for outputting, based on the set of antenna identification signals, analog reception combining information. The network entity 1302, in some aspects, may include means for communicating with the UE based on the analog reception combining information. The network entity 1302, in some aspects, may include means for obtaining a capability indication of support for the analog reception combining at the UE. The network entity 1302, in some aspects, may include means for obtaining a set of one or more parameters related to the analog reception combining. The network entity 1302, in some aspects, may include means for obtaining, from the UE and based on the configuration for the antenna identification, an additional set of antenna identification signals. The network entity 1302, in some aspects, may include means for outputting, based on the additional set of antenna identification signals, updated analog reception combining information. The network entity 1302, in some aspects, may include means for communicating with the UE based on the updated analog reception combining information. The network entity 1302 may further include means for performing any of the aspects described in connection with the flowcharts in FIG. 10 or 11, and/or performed by the base station in the communication flow of FIG. 7. The means may be the analog Rx combining configuration component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects, next generation bands may go to higher carriers (or frequencies), and the number of UE antennas may increase accordingly. Having all of these lanes processed digitally will incur high power consumption. The disclosure above describes a method for a base station to assist a UE with reducing (optimally combining or selecting) the number of analog lanes down to a smaller number of digital lanes.

Various aspects relate generally to analog reception combining (e.g., via Rx analog combining). Some aspects more specifically relate to a multi-antenna transmitting device (e.g., a network device) and/or a multi-antenna receiving device (e.g., a UE) associated with an Rx antenna analog precoding and/or selection based on the knowledge of the full channel between the transmitting device and the receiving device. In some examples, the UE may be configured to obtain a configuration for an antenna identification associated with a plurality of antennas at the UE. The UE may further be configured to output, for a network device and based on the configuration for the antenna identification, a set of antenna identification signals and obtain, based on the set of antenna identification signals, analog reception combining information. The UE may also be configured to communicate with the network device based on the analog reception combining information. In some examples, the network device may be configured to output a configuration for an antenna identification associated with a plurality of antennas at a UE. The network device may further be configured to obtain, from the UE and based on the configuration for the antenna identification, a set of antenna identification signals and output, based on the set of antenna identification signals, analog reception combining information. The network device may also be configured to communicate with the UE based on the analog reception combining information.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE) associated with analog reception combining, comprising: obtaining a configuration for an antenna identification associated with a plurality of antennas at the UE; outputting, for a network device and based on the configuration for the antenna identification, a set of antenna identification signals; obtaining, based on the set of antenna identification signals, analog reception combining information; and communicating with the network device based on the analog reception combining information.

Aspect 2 is the method of aspect 1, further comprising: outputting a capability indication of support for the analog reception combining; and outputting a set of one or more parameters related to the analog reception combining, wherein the configuration is based on at least one of the capability indication or the set of one or more parameters related to the analog reception combining.

Aspect 3 is the method of aspect 2, wherein the set of one or more parameters related to the analog reception combining comprise one or more of: a first number of analog processing chains at the UE; a second number of digital processing chains at the UE, wherein the first number of analog processing chains is greater than the second number of digital processing chains; whether a precoding method or a selection method is a desired method for reducing at least one of a third number of analog processing chains or a fourth number of digital processing chains in association with the analog reception combining; a resolution of a phase shifter at the UE; a resolution of an amplitude adjustment at the UE; or a fifth number of bands associated with each of the plurality of antennas associated with the UE.

Aspect 4 is the method of any of aspects 1 to 3, wherein the configuration for the antenna identification comprises one or more of: a third indication of a first allocation of at least one frequency resource for each antenna of the plurality of antennas; a fourth indication of a second allocation of at least one time resource for each antenna of the plurality of antennas; or a fifth indication of a code associated with each antenna of the plurality of antennas.

Aspect 5 is the method of aspect 4, wherein the set of antenna identification signals comprises a plurality of reference signals associated with a corresponding antenna in the plurality of antennas and outputting the set of antenna identification signals comprises: transmitting each of the plurality of reference signals via the corresponding antenna via the at least one frequency resource and the at least one time resource for the corresponding antenna.

Aspect 6 is the method of any of aspects 1 to 5, wherein the analog reception combining information is associated with downlink control information (DCI).

Aspect 7 is the method of any of aspects 1 to 6, wherein the analog reception combining information indicates at least one of a selection of a subset of antennas of the plurality of antennas at the UE or a set of weights associated with each antenna of the plurality of antennas at the UE.

Aspect 8 is the method of aspect 7, wherein the set of weights associated with a first antenna of the plurality of antennas at the UE comprises a plurality of weights corresponding to a plurality of frequency bands associated with the first antenna.

Aspect 9 is the method of any of aspects 1 to 8, further comprising: outputting, for the network device and based on the configuration for the antenna identification, an additional set of antenna identification signals; obtaining, based on the set of antenna identification signals, updated analog reception combining information; and communicating with the network device based on the updated analog reception combining information.

Aspect 10 is the method of aspect 9, wherein the additional set of antenna identification signals are output based on one of a periodicity associated with outputting the set of antenna identification signals or a triggering event, wherein the triggering event is one of a request from the network device or a condition detected at the UE.

Aspect 11 is a method of wireless communication at a network device associated with analog reception combining, comprising: outputting a configuration for an antenna identification associated with a plurality of antennas at a user equipment (UE); obtaining, from the UE and based on the configuration for the antenna identification, a set of antenna identification signals; outputting, based on the set of antenna identification signals, analog reception combining information; and communicating with the UE based on the analog reception combining information.

Aspect 12 is the method of aspect 11, further comprising: obtaining a capability indication of support for the analog reception combining at the UE; and obtaining a set of one or more parameters related to the analog reception combining, wherein the configuration is based on at least one of the capability indication or the set of one or more parameters related to the analog reception combining.

Aspect 13 is the method of aspect 12, wherein the set of one or more parameters related to the analog reception combining comprise one or more of: a first number of analog processing chains at the UE; a second number of digital processing chains at the UE, wherein the first number of analog processing chains is greater than the second number of digital processing chains; whether a precoding method or a selection method is a desired method for reducing at least one of a third number of analog processing chains or a fourth number of digital processing chains in association with the analog reception combining; a resolution of a phase shifter at the UE; a resolution of an amplitude adjustment at the UE; or a fifth number of bands associated with each of the plurality of antennas associated with the UE.

Aspect 14 is the method of any of aspects 11 to 13, wherein the configuration for the antenna identification comprises one or more of: a third indication of a first allocation of at least one frequency resource for each antenna of the plurality of antennas; a fourth indication of a second allocation of at least one time resource for each antenna of the plurality of antennas; or a fifth indication of a code associated with each antenna of the plurality of antennas.

Aspect 15 is the method of any of aspects 11 to 14, wherein the analog reception combining information is associated with downlink control information (DCI).

Aspect 16 is the method of any of aspects 11 to 15, further comprising: obtaining, from the UE and based on the configuration for the antenna identification, an additional set of antenna identification signals; outputting, based on the additional set of antenna identification signals, updated analog reception combining information; and communicating with the UE based on the updated analog reception combining information.

Aspect 17 is the method of aspect 16, wherein the additional set of antenna identification signals are output based on one of a periodicity associated with outputting the set of antenna identification signals or a triggering event, wherein the triggering event is one of a request from the network device or a condition detected at the UE.

Aspect 18 is an apparatus for wireless communication at a device including a memory and at least one processor coupled to the memory and, based at least in part on information stored in the memory, the at least one processor is configured to implement any of aspects 1 to 10.

Aspect 19 is the apparatus of aspect 18, further including a transceiver or an antenna coupled to the at least one processor.

Aspect 20 is an apparatus for wireless communication at a device including means for implementing any of aspects 1 to 10.

Aspect 21 is a computer-readable medium (e.g., a non-transitory computer-readable medium) storing computer executable code, where the code when executed by a processor causes the processor to implement any of aspects 1 to 10.

Aspect 22 is an apparatus for wireless communication at a device including a memory and at least one processor coupled to the memory and, based at least in part on information stored in the memory, the at least one processor is configured to implement any of aspects 11 to 17.

Aspect 23 is the apparatus of aspect 22, further including a transceiver or an antenna coupled to the at least one processor.

Aspect 24 is an apparatus for wireless communication at a device including means for implementing any of aspects 11 to 17.

Aspect 25 is a computer-readable medium (e.g., a non-transitory computer-readable medium) storing computer executable code, where the code when executed by a processor causes the processor to implement any of aspects 11 to 17.

What is claimed is:

1. An apparatus for wireless communication at a user equipment (UE) associated with analog reception combining, comprising:
at least one memory; and
at least one processor coupled to the at least one memory and, based at least in part on stored information that is stored in the at least one memory, the at least one processor, individually or in any combination, is configured to:
obtain a configuration for an antenna identification associated with a plurality of antennas at the UE;
output, for a network device and based on the configuration for the antenna identification, a set of antenna identification signals;
obtain, based on the set of antenna identification signals, analog reception combining information; and
communicate with the network device based on the analog reception combining information.

2. The apparatus of claim 1, wherein the at least one processor, individually or in any combination, is further configured to:
output a capability indication of support for the analog reception combining; and
output a set of one or more parameters related to the analog reception combining, wherein the configuration is based on at least one of the capability indication or the set of one or more parameters related to the analog reception combining.

3. The apparatus of claim 2, wherein the set of one or more parameters related to the analog reception combining comprise one or more of:
a first number of analog processing chains at the UE;
a second number of digital processing chains at the UE, wherein the first number of analog processing chains is greater than the second number of digital processing chains;
whether a precoding method or a selection method is a desired method for reducing at least one of a third number of analog processing chains or a fourth number of digital processing chains in association with the analog reception combining;
a resolution of a phase shifter at the UE;
a resolution of an amplitude adjustment at the UE; or
a fifth number of bands associated with each of the plurality of antennas associated with the UE.

4. The apparatus of claim 1, wherein the configuration for the antenna identification comprises one or more of:
a third indication of a first allocation of at least one frequency resource for each antenna of the plurality of antennas;
a fourth indication of a second allocation of at least one time resource for each antenna of the plurality of antennas; or
a fifth indication of a code associated with each antenna of the plurality of antennas.

5. The apparatus of claim 4, wherein the set of antenna identification signals comprises a plurality of reference signals associated with a corresponding antenna in the plurality of antennas and wherein, to output the set of antenna identification signals, the at least one processor, individually or in any combination, is further configured to:
transmit each of the plurality of reference signals via the corresponding antenna via the at least one frequency resource and the at least one time resource for the corresponding antenna.

6. The apparatus of claim 1, wherein the analog reception combining information is associated with downlink control information (DCI).

7. The apparatus of claim 1, wherein the analog reception combining information indicates at least one of a selection of a subset of antennas of the plurality of antennas at the UE or a set of weights associated with each antenna of the plurality of antennas at the UE.

8. The apparatus of claim 7, wherein the set of weights associated with a first antenna of the plurality of antennas at the UE comprises a plurality of weights corresponding to a plurality of frequency bands associated with the first antenna.

9. The apparatus of claim 1, wherein the at least one processor, individually or in any combination, is further configured to:
output, for the network device and based on the configuration for the antenna identification, an additional set of antenna identification signals;
obtain, based on the set of antenna identification signals, updated analog reception combining information; and
communicate with the network device based on the updated analog reception combining information.

10. The apparatus of claim 9, wherein the at least one processor, individually or in any combination, is configured to output the additional set of antenna identification signals based on one of a periodicity associated with outputting the set of antenna identification signals or a triggering event, wherein the triggering event is one of a request from the network device or a condition detected at the UE.

11. An apparatus for wireless communication at a network node associated with analog reception combining, comprising:
at least one memory; and
at least one processor coupled to the at least one memory and, based at least in part on stored information that is stored in the at least one memory, the at least one processor, individually or in any combination, is configured to:
output a configuration for an antenna identification associated with a plurality of antennas at a user equipment (UE);
obtain, from the UE and based on the configuration for the antenna identification, a set of antenna identification signals;
output, based on the set of antenna identification signals, analog reception combining information; and
communicate with the UE based on the analog reception combining information.

12. The apparatus of claim 11, wherein the at least one processor, individually or in any combination, is further configured to:
obtain a capability indication of support for the analog reception combining at the UE; and
obtain a set of one or more parameters related to the analog reception combining, wherein the configuration is based on at least one of the capability indication or the set of one or more parameters related to the analog reception combining.

13. The apparatus of claim 12, wherein the set of one or more parameters related to the analog reception combining comprise one or more of:
a first number of analog processing chains at the UE;
a second number of digital processing chains at the UE, wherein the first number of analog processing chains is greater than the second number of digital processing chains;
whether a precoding method or a selection method is a desired method for reducing at least one of a third number of analog processing chains or a fourth number of digital processing chains in association with the analog reception combining;
a resolution of a phase shifter at the UE;
a resolution of an amplitude adjustment at the UE, or
a fifth number of bands associated with each of the plurality of antennas associated with the UE.

14. The apparatus of claim 11, wherein the configuration for the antenna identification comprises one or more of:
a third indication of a first allocation of at least one frequency resource for each antenna of the plurality of antennas;
a fourth indication of a second allocation of at least one time resource for each antenna of the plurality of antennas; or
a fifth indication of a code associated with each antenna of the plurality of antennas.

15. The apparatus of claim 11, wherein the analog reception combining information is associated with downlink control information (DCI).

16. The apparatus of claim 11, wherein the at least one processor, individually or in any combination, is further configured to:
obtain, from the UE and based on the configuration for the antenna identification, an additional set of antenna identification signals;
output, based on the additional set of antenna identification signals, updated analog reception combining information; and
communicate with the UE based on the updated analog reception combining information.

17. The apparatus of claim 16, the at least one processor, individually or in any combination, is configured to obtain the additional set of antenna identification signals based on one of a periodicity associated with outputting the set of antenna identification signals or a triggering event, wherein the triggering event is one of a request from the apparatus or a condition detected at the apparatus.

18. A method of wireless communication at a user equipment (UE) associated with analog reception combining, comprising:
obtaining a configuration for an antenna identification associated with a plurality of antennas at the UE;
outputting, for a network device and based on the configuration for the antenna identification, a set of antenna identification signals;
obtaining, based on the set of antenna identification signals, analog reception combining information; and
communicating with the network device based on the analog reception combining information.

19. The method of claim 18, further comprising:
outputting a capability indication of support for the analog reception combining; and
outputting a set of one or more parameters related to the analog reception combining, wherein the configuration is based on at least one of the capability indication or the set of one or more parameters related to the analog reception combining.

20. The method of claim 19, wherein the set of one or more parameters related to the analog reception combining comprise one or more of:
a first number of analog processing chains at the UE;
a second number of digital processing chains at the UE, wherein the first number of analog processing chains is greater than the second number of digital processing chains;
whether a precoding method or a selection method is a desired method for reducing at least one of a third number of analog processing chains or a fourth number of digital processing chains in association with the analog reception combining;
a resolution of a phase shifter at the UE;
a resolution of an amplitude adjustment at the UE; or
a fifth number of bands associated with each of the plurality of antennas associated with the UE.

21. The method of claim 18, wherein the configuration for the antenna identification comprises one or more of:
a third indication of a first allocation of at least one frequency resource for each antenna of the plurality of antennas;
a fourth indication of a second allocation of at least one time resource for each antenna of the plurality of antennas; or
a fifth indication of a code associated with each antenna of the plurality of antennas.

22. The method of claim 21, wherein the set of antenna identification signals comprises a plurality of reference signals associated with a corresponding antenna in the plurality of antennas and outputting the set of antenna identification signals comprises:
transmitting each of the plurality of reference signals via the corresponding antenna via the at least one frequency resource and the at least one time resource for the corresponding antenna.

23. The method of claim 18, wherein the analog reception combining information is associated with downlink control information (DCI), wherein the analog reception combining information indicates at least one of a selection of a subset of antennas of the plurality of antennas at the UE or a set of weights associated with each antenna of the plurality of antennas at the UE.

24. The method of claim 23, wherein the set of weights associated with a first antenna of the plurality of antennas at the UE comprises a plurality of weights corresponding to a plurality of frequency bands associated with the first antenna.

25. The method of claim 18, further comprising:
outputting, for the network device and based on the configuration for the antenna identification, an additional set of antenna identification signals;
obtaining, based on the set of antenna identification signals, updated analog reception combining information; and
communicating with the network device based on the updated analog reception combining information.

26. The method of claim 25, wherein the additional set of antenna identification signals are output based on one of a periodicity associated with outputting the set of antenna identification signals or a triggering event, wherein the triggering event is one of a request from the network device or a condition detected at the UE.

27. A method of wireless communication at a network device associated with analog reception combining, comprising:
outputting a configuration for an antenna identification associated with a plurality of antennas at a user equipment (UE);
obtaining, from the UE and based on the configuration for the antenna identification, a set of antenna identification signals;
outputting, based on the set of antenna identification signals, analog reception combining information; and
communicating with the UE based on the analog reception combining information.

28. The method of claim 27, further comprising:
obtaining a capability indication of support for the analog reception combining at the UE; and
obtaining a set of one or more parameters related to the analog reception combining, wherein the configuration is based on at least one of the capability indication or the set of one or more parameters related to the analog reception combining.

29. The method of claim 28, wherein the set of one or more parameters related to the analog reception combining comprise one or more of:
a first number of analog processing chains at the UE;
a second number of digital processing chains at the UE, wherein the first number of analog processing chains is greater than the second number of digital processing chains;
whether a precoding method or a selection method is a desired method for reducing at least one of a third number of analog processing chains or a fourth number of digital processing chains in association with the analog reception combining;
a resolution of a phase shifter at the UE;
a resolution of an amplitude adjustment at the UE; or
a fifth number of bands associated with each of the plurality of antennas associated with the UE.

30. The method of claim 27, wherein the configuration for the antenna identification comprises one or more of:
a third indication of a first allocation of at least one frequency resource for each antenna of the plurality of antennas;
a fourth indication of a second allocation of at least one time resource for each antenna of the plurality of antennas; or
a fifth indication of a code associated with each antenna of the plurality of antennas.
